(19) United States
(12) Patent Application Publication
(10) Pub. No.: US 2009/0002573 A1
(43) Pub. Date: Jan. 1, 2009

(54) Image Display Device

(76) Inventors: Nobuhiko Hosotani, Mobara (JP); Tadayoshi Tachibana, Mobara (JP); Tatsuro Kato, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/127,029

(22) Filed: May 27, 2008

(30) Foreign Application Priority Data
Jun. 7, 2007 (JP) 2007-151188

(51) Int. Cl. H04N 5/66

(52) U.S. Cl. 348/739

(57) ABSTRACT

A first translucent conductive layer is disposed on a front surface of a front substrate, a translucent insulating member is disposed on a front surface of the first translucent conductive layer, and a second translucent conductive layer held at the ground potential is disposed on a front surface of the translucent insulating member. According to the invention, an image display device, which prevents the abnormal discharge in the vacuum panel from occurring, and has high quality and reliability and long life, can be provided.

### CROSS-REFERENCE TO RELATED APPLICATION

The present application claims priority from Japanese application JP2007-151188 filed on Jun. 7, 2007, the content of which is hereby incorporated by reference into this application.

### BACKGROUND OF THE INVENTION

1. Technical Field

The present invention relates to a light emitting flat panel image display device, and in particular to an image display device having electron sources arranged in a matrix.

2. Related Art

As an example of a light emitting flat panel display (FPD) having electron sources arranged in a matrix, there are known a field emission display (FED) and an electron emitter display using microscopic cold cathodes suitable for integration. As such cold cathodes, there can be cited electron sources such as a Spindt type electron source, a surface-conduction electron source, a carbon nanotube electron source, a metal-insulator-metal (MIM) type having metal-insulator-metal layers, a metal-insulator-semiconductor (MIS) type having metal-insulator-semiconductor layers, and a metal-insulator-semiconductor-metal type electron source.

A typical light emitting FPD is provided with a rear panel having such electron sources as described above disposed on a rear substrate formed of a glass plate, a front panel having a fluorescent layer and an anode for forming an electric field for causing the electrons emitted from the electron sources to collide with the fluorescent layer disposed on a front substrate formed of a glass plate, and a frame member for keeping the inside space between the both panels opposed to each other to have a predetermined distance, and has a configuration of keeping the display space formed by the both panels and the frame member vacuum, and is configured by combining this display panel with a drive circuit.

Further, on the rear substrate of the rear panel, there are disposed a plurality of scanning signal lines extending in one direction and arranged in parallel in another direction perpendicular to the one direction to which the scanning signal is applied sequentially in the another direction, and further, on the rear substrate, there are also disposed a plurality of image signal lines extending in the another direction and arranged in parallel in the one direction so as to intersect the scanning signal lines. In typical configurations, the electron sources described above are additionally disposed in the vicinities of the intersections between the scanning signal lines and the image signal lines, respectively, and the scanning signal lines and the electron sources are respectively connected to each other via feeding electrodes, thus supplying the current from the scanning signal lines to the electron sources.

Further, each of the electron sources forms a pair together with the corresponding part of the fluorescent layer to form a unit pixel. In general, the unit pixels of three colors, red (R), green (G), and blue (B) form one pixel (a color pixel). It should be noted that in the case of the color pixel, the unit pixel is also referred to as a subpixel.

In addition to the configuration described above, in the image display device, a plurality of gap holding members (spacer) is disposed and fixed in the display area surrounded by the frame member between the rear panel and the front panel, and thus holding the gap between the both panels to a predetermined gap in cooperation with the frame member. The spacers are each formed of a plate-like member made of an insulating material such as glass or ceramics or of a member with some conductivity, and generally disposed for every plurality of pixels at positions where the operations of the pixels are not disturbed.

Further, the frame member functioning as a sealing frame is fixed on the inside peripheries of the rear substrate and the front substrate with a sealing member such as frit glass, and the fixed section is hermeticallyed to form a sealing area. The degree of vacuum of the inside of the display area formed by the both substrates and the frame member is, for example, roughly 10⁻⁵ through 10⁻⁷ Torr.

Scanning signal line extraction terminals connected to the scanning signal lines provided to the rear substrate and the image signal line extraction terminals connected to the image signal lines penetrate the sealing area formed of the frame member and the both substrates.

Regarding the light emitting image display device as described above, JP-A-2000-235837 discloses a configuration provided with a voltage regulating conductive layer disposed on the outer surface of the front substrate and current limiting means for setting the voltage of the voltage regulating conductive layer to substantially the same voltage as the acceleration voltage to limit the current value flowing through the voltage regulating conductive layer, thereby assuring safely in the case in which a human touches the voltage regulating conductive layer.

In the image display device of this kind, a black matrix film, a fluorescent film, a metal back film, and soon are formed inside the front substrate, and a high voltage of about 3 KV through 12 KV is applied thereto in order for exciting the fluorescent film. Further, the gap between the opposed inside surfaces of the front substrate and the rear surface is in a range of about 1 mm through 3 mm, and abnormal discharge is caused between the opposed surfaces by turbulence in the electric field, etc.

As one of the causes of inducing the abnormal discharge, there can be cited accumulation of electric charge from the outside of the vacuum panel and electric field distortions, etc. There is a problem that when the electric filed is significantly distorted in the outside of the vacuum panel, the electric field distribution on the inside surface of the front substrate of the vacuum panel is disturbed which causes the abnormal discharge.

### SUMMARY

Therefore, the invention has been made for solving the problem in the related art described above, and has an object of providing an image display device, which prevents the abnormal discharge in the vacuum panel from occurring, and has high quality and reliability and long life.

In order for achieving such an object, an image display device according to the invention includes a first translucent conductive layer disposed on a front surface of the front substrate, a translucent insulating member disposed on a front surface of the first translucent conductive layer, and a second translucent conductive layer held at a ground potential and disposed on a front surface of the translucent insulating member.

Another image display device according to the invention includes a first translucent conductive layer held at a lower potential than the potential of the acceleration electrode disposed on a front surface of the front substrate, a translucent insulating member disposed on a front surface of the first translucent conductive layer, and a second translucent conductive layer held at a ground potential and disposed on a front surface of the translucent insulating member.

Further, in the image display device according to the invention having the configuration described above, it is preferable that surface resistances of the first translucent conductive layer and the second translucent conductive layer have values within a range of 10² Ω/sq through 10¹¹ Ω/sq.

Further, in the image display device according to the invention having the configuration described above, it is preferable that the translucent insulating member is an insulating layer.

Further, in the image display device according to the invention having the configuration described above, it is preferable that the translucent insulating member is a glass plate.

According to the first aspect of the invention, the influence of the electric field distortions in the outside the front substrate is shielded by the first translucent conductive layer, thus the potential variation can be prevented form being transferred to the inside of the vacuum panel, and consequently, there can be obtained an extremely preferable advantage that the abnormal discharge in the vacuum panel can be prevented, and the image display device having high quality and reliability, and longer life can be realized.

Further, according to the second aspect of the invention, when the abnormal discharge occurs between the front substrate and the rear substrate, the potential variation on the inside surface of the front substrate is reduced by the electric field applied to the outside of the front substrate. Further, since the influence of the potential variation in the outside of the front substrate is shielded by the first translucent conductive layer and the transfer of the potential variation to the inside of the vacuum panel can be prevented, there can be obtained the extremely preferable advantage that the image display device having high quality and reliability, and longer life can be realized.

### BRIEF DESCRIPTION OF THE DRAWINGS

FIGS. 1A and 1B are schematic diagrams for explaining a first embodiment of an image display device according to the invention, wherein FIG. 1A is a plan view viewed from the front substrate side, and FIG. 1B is a side view of FIG. 1A.

FIG. 2 is a schematic plan view along the A-A line shown in FIG. 1B.

FIG. 3 is a schematic cross-sectional view along the B-B line shown in FIG. 2.

FIG. 4 is a schematic cross-sectional view along the C-C line shown in FIG. 2.

FIG. 5 is a schematic cross-sectional view along the D-D line shown in FIG. 2.

FIG. 6 is an enlarged cross-sectional view of a substantial part of a display panel of the image display device.

FIG. 7 is a diagram schematically showing the configuration shown in FIG. 6.

FIG. 8 is an enlarged cross-sectional view of a substantial part of a display panel corresponding to FIG. 6, and shows another embodiment of the image display device according to the invention.

FIG. 9 is a diagram schematically showing the configuration shown in FIG. 8.

### DESCRIPTION OF THE PREFERRED EMBODIMENTS

Hereinafter, the invention will be explained in detail with reference to the accompanying drawings of some embodiments.

### First Embodiment

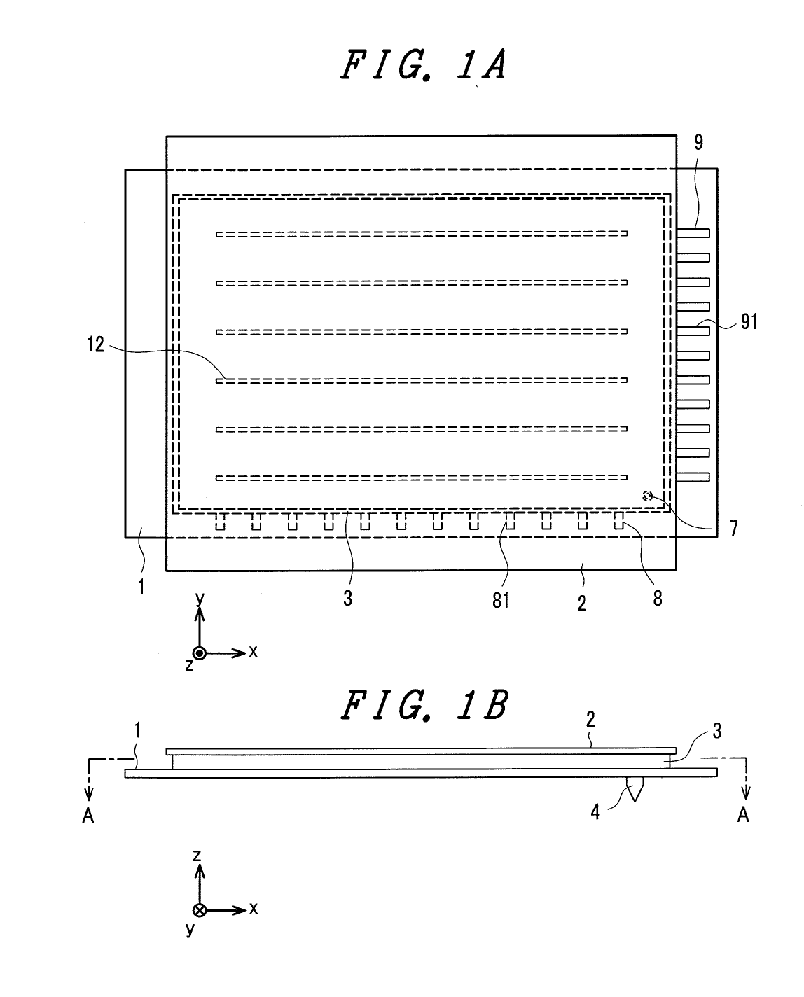

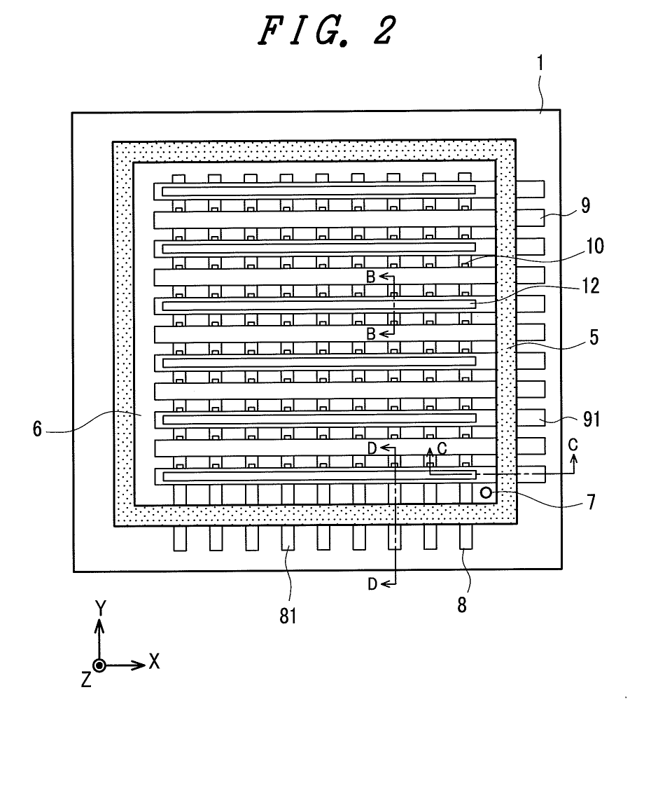

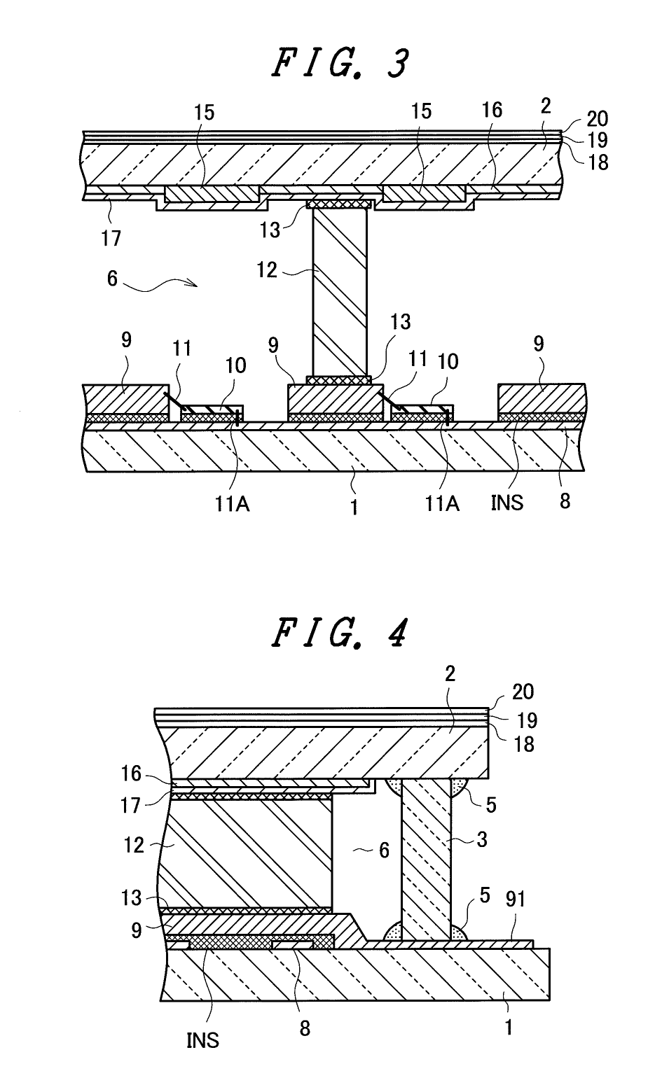

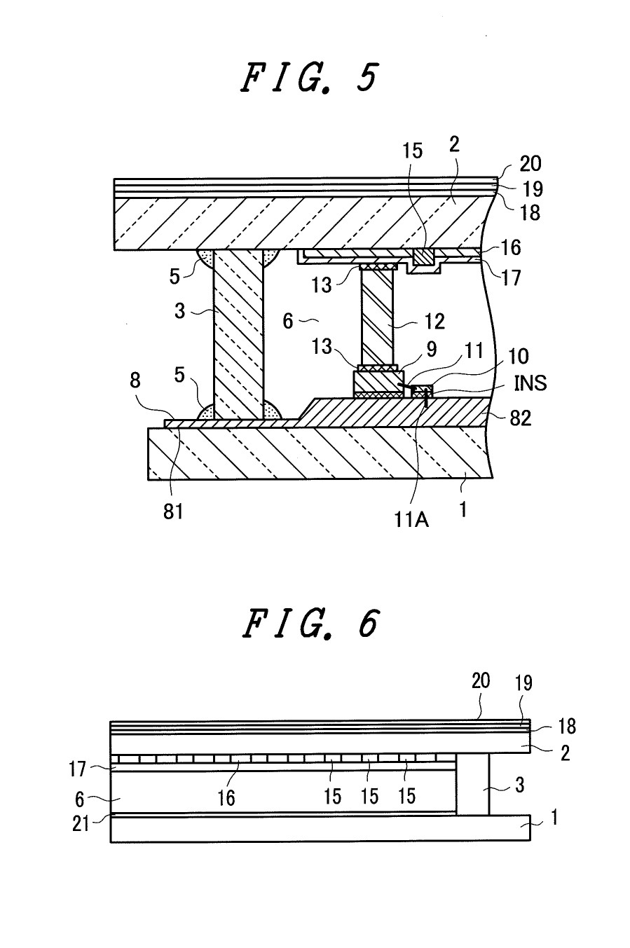

FIGS. 1A, 1B, and 2 through 4 are schematic diagrams for explaining a first embodiment of the image display device according to the invention, wherein FIG. 1A is a plan view viewed from a front substrate side, FIG. 1B is a side view of FIG. 1A, FIG. 2 is a plan view along the A-A line shown in FIG. 1B, FIG. 3 is a cross-sectional view along the B-B line shown in FIG. 2, FIG. 4 is a cross-sectional view along the C-C line shown in FIG. 2, and FIG. 5 is a cross-sectional view along the D-D line shown in FIG. 2.

In FIGS. 1A, 1B, and 2 through 5, the reference numeral 1 denotes a rear substrate, the reference numeral 2 denotes a front substrate, the reference numeral 3 denotes a frame member, the reference numeral 4 denotes an evacuation tube, the reference numeral 5 denotes a seal member, the reference numeral 6 denotes a display area, the reference numeral 7 denotes a through hole, the reference numeral 8 denotes picture signal lines, the reference numeral 9 denotes scanning signal lines, the reference numeral 10 denotes electron sources, the reference numeral 11 denotes connection lines, the reference numeral 12 denotes spacers, the reference numeral 13 denotes adhesive members, the reference numeral 14 denotes a protective electrode, the reference numeral 15 denotes a fluorescent layer, the reference numeral 16 denotes a light blocking black matrix (BM) film, the reference numeral 17 denotes a metal back (an acceleration electrode) formed of a metal thin film, the reference numeral 18 denotes a first translucent conductive layer, the reference numeral 19 denotes a translucent insulating member, and the reference numeral 20 denotes a second translucent conductive layer.

These rear substrate 1 and front substrate 2 are each formed of a glass plate with a thickness of a several millimeters, e.g., 1 through 10 mm, and the both of the rear and front substrates 1, 2 are each formed to have a substantially rectangular shape and laminated with a predetermined gap therebetween. The reference numeral 3 denotes the frame member formed to have a frame-like shape, and the frame member 3 is formed, for example, of a sintered body of the frit glass or a glass plate, to have a substantially rectangular shape by itself or in combination of a plurality of members, and is interposed between the rear substrate 1 and the front substrate 2.

The frame member 3 is interposed between the rear substrate 1 and the front substrate 2 on the peripheral section thereof, and has both end surfaces hermetically sealed to the rear substrate 1 and the front substrate 2, respectively. The thickness of the frame member 3 is in a range of several millimeters through several tens of millimeters, and the height thereof is arranged to be substantially the same size as the distance between the rear substrates 1 and the front substrate 2. The reference numeral 4 denotes the evacuation tube, and the evacuation tube 4 is hermetically sealed communicated with a hole provided to the rear surface of the rear substrate 1 so as to penetrate the rear surface. The reference numeral 5 denotes the seal member, and the seal member 5 is formed, for example, of the frit glass, and hermetically sealed bonding the frame member 3 with the rear substrate 1 and with the front substrates 2.

The space including the display area 6 and surrounded by the rear substrate 1, the front substrate 2, the frame member 3, and the seal member 5 is evacuated via the evacuation tube 4, and is kept vacuum with the degree of vacuum of, for example, 10⁻⁵ through 10⁻⁷ Torr. Further, the evacuation tube 4 is attached to the outside surface of the rear substrate 1 as described above, communicated with the through hole 7 provided so as to penetrate the rear substrate 1, and sealed after the evacuation is completed.

The reference numeral 8 denotes the picture signal lines, and the picture signal lines 8 are disposed on the inside surface of the rear substrate 1, extending in one direction (a Y direction) and arranged in parallel in another direction (an X direction) using a metal material described below. The picture signal lines 8 extend from the space including the display area 6 to an end surface of the rear substrate 1 passing airtightly through the sealing area between the frame member 3 and the rear substrate 1. The outer tip portion of each of the picture signal lines 8 from the sealing area is defined as a picture signal line extraction terminal 81.

The reference numeral 9 denotes the scanning signal lines, and the scanning signal lines 9 are disposed above the picture signal lines 8 extending in the another direction (the X direction) intersecting the picture signal lines 8, and arranged in parallel in the one direction (the Y direction) using a metal material described below. The scanning signal lines 9 extend from the space including the display area 6 to the vicinity of the end surface of the rear substrate 1 passing airtightly through the sealing area between the frame member 3 and the rear substrate 1. The outer tip portion of each of the scanning signal lines 9 from the sealing area is defined as a scanning signal line extraction terminal 91.

The reference numeral 10 denotes MIM type electron sources, for example, as a kind of electron sources, and the electron sources 10 are respectively disposed in the vicinities of the intersections between the scanning signal lines 9 and the picture signal lines 8. Further, each of the electron sources 10 is connected to the scanning signal line 9 via a connection line 11. Further, there is disposed an inter layer insulating film INS between the picture signal lines 8, and upper electrodes of the electron sources 10 and the scanning signal lines 9.

It should be noted here that as the picture signal lines 8, Al (aluminum) films, for example, are used, while as the scanning signal lines 9, Cr/Al/Cr films or Cr/Cu/Cr films, for example, are used. Further, although the line extraction terminals 81, 91 are provided respectively on the both ends of the signal lines, they can be provided on either one of the ends.

Then, the reference numeral 12 denotes the spacers, and the spacers 12 are each formed of a plate-like member made of an insulating material such as glass or ceramics or of a member with some conductivity, and generally disposed for every plurality of pixels at positions where the operations of the pixels are not disturbed. The spacers 12 have specific resistances of about 10⁸ Ωcm through 10⁹ Ωcm, and a configuration with little unevenness in distribution of the resistance as a whole. Further, the spacers 12 are disposed in a erect manner substantially in parallel to the frame member 3 on every other scanning signal line 9, and are bonded with the rear substrate 1 and the front substrate 2 via the adhesive members 13. Still further, the spacers 12 can be fixedly bonded with the substrate only on one end, and regarding the arrangement thereof, each of the spacers 12 is disposed for every plurality of pixels at positions where the operations of the pixels are not disturbed. Further, it is also possible to dispose the spacers 12 on every several scanning signal lines 9.

The dimensions of the spacers 12 are determined in accordance with the dimensions of the substrates, the height of the frame member 3, the materials of the substrates, the distance between the spacers, the material of the spacers, and so on, and in general, the height thereof is substantially the same as the size of the frame member 3 described above, the thickness thereof is in a range of several tens of micrometers through several millimeters. The length of the spacer is in a range of about 20 mm through 1000 mm, or a longer size is also possible. Preferably, the range of about 80 mm through 300 mm will be a practicable value.

On the other hand, on the inside surface of the front substrate 2 to which one end of each of the spacers 12 is fixed, there are disposed fluorescent layers 15 for red, green, or blue in windows partitioned by a light blocking black matrix (BM) film 16, and further, the metal back (an acceleration electrode) 17 formed of a metal thin film is formed so as to cover these components using, for example, an evaporation method, thereby forming the fluorescent surface. In the operation conditions, an anode voltage of about 3 KV through 20 KV is applied to the fluorescent surface. The metal back 17 is a light reflection film for reflecting the light emitted towards the opposite side of the front substrate 2, namely towards the rear substrate 1 side, and emitting it towards the front substrate 2 and for increasing a taking out efficiency of the light emitted, and at the same time has a function of preventing the charge on the surface of the fluorescent particles.

As the fluorescent material, for example, Y₂O₃:Eu or Y₂O₂S:Eu can be used for red, ZnS:Cu,Al or Y₂SiO₅:Tb can be used for green, and ZnS:Ag,Cl or ZnS:Ag,Al can be used for blue. The fluorescent layer 15 includes the fluorescent particles with average particle size of, for example, about 4 μm through 9 μm, and has a thickness of, for example, about 10 μm through 20 μm.

The reference numeral 18 denotes the first translucent conductive layer, and as shown in the enlarged diagram of a substantial part of the display panel shown in FIG. 6, the first translucent conductive layer 18 is formed by depositing, for example, ITO on the front surface of the front substrate 2 using an evaporation method with a thickness of, for example, about 100 nm. The first translucent conductive layer 18 is formed in a floating condition, and has a function as a shield conductive layer.

Further, the reference numeral 19 denotes the translucent insulating member, and the translucent insulating member 19 is provided by bonding, for example, a translucent glass plate with a thickness of several millimeters, e.g., about 1 through 5 mm on the front surface of the first translucent conductive layer 18 with an adhesive or the like. Further, the reference numeral 20 denotes a second translucent conductive layer, and the second translucent conductive layer 20 is formed by depositing, for example, ATO on the front surface of the insulating member 19 using an evaporation method with a thickness of about 200 nm, and has a function as an antistatic layer.

It should be noted that the surface resistances of the first translucent conductive layer 18 and the second translucent conductive layer 20 can separately be selected within a range of 10² Ω/sq through 10¹¹ Ω/sq.

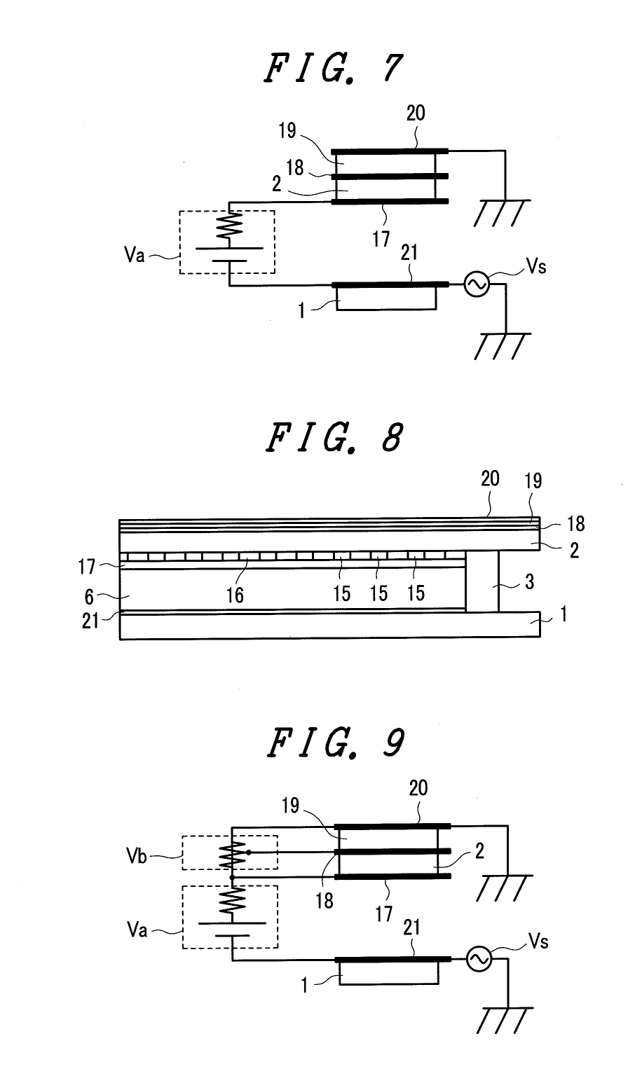

FIG. 7 is a diagram schematically showing the configuration shown in FIG. 6. As shown in FIG. 7, the first translucent conductive layer 18 formed on the front surface side of the front substrate 2 functions as the shield conductive layer (the floating layer). The second translucent conductive layer 20 formed on the first translucent conductive layer 18 via the translucent insulating member 19 is connected to the ground potential as the antistatic layer.

Further, a high voltage power supply Va is connected between the metal back (the acceleration electrode) 17 formed of a metal thin film and formed on the inside surface of the front substrate 2 and a wiring layer 21 such as the picture signal lines 8 and the scanning signal lines 9 formed on the inside surface of the rear substrate 1 opposed thereto. Meanwhile, a signal power supply Vs is connected to the wiring layer 21 such as the picture signal lines 8 and the scanning signal lines 9 formed on the inside surface of the rear substrate 1.

According to the configuration of the first embodiment, the first translucent conductive layer 18 as the shield conductive layer is formed on the outside surface of the front substrate 2, and the surface of the front substrate is grounded by the second translucent conductive layer 20 as the antistatic layer disposed thereon via the translucent insulating member 19, thus the electric field distortions in the outside of the panel can be shielded by the first translucent conductive layer 18, thereby preventing the potential variations from being transferred to the inside of the vacuum panel.

### Second Embodiment

FIG. 8 is an enlarged diagram of a substantial part of the display panel showing another embodiment of the image display device according to the invention, wherein the same parts as in the drawings described above will be denoted with the same reference numerals, and the explanations therefor will be omitted. FIG. 8 is different from FIG. 6 in that the first translucent conductive layer 18 formed on the front surface side of the front substrate 2 has a function as a voltage applying layer. Further, as shown in FIG. 9 with the schematic diagram thereof, a low voltage power supply Vb having a voltage lower than that of the high voltage power supply Va is connected to the first translucent conductive layer 18.

According to the configuration of the second embodiment, the first translucent conductive layer 18 as the voltage applying layer is formed on the outside surface of the front substrate 2, and the surface of the front substrate is grounded by the second translucent conductive layer 20 as the antistatic layer disposed thereon via the translucent insulating member 19, thus the influence of the electric field distortions in the outside of the panel can be prevented from being transferred to the inside of the vacuum panel. Further, the first translucent conductive layer 18 as the voltage applying layer for connecting the low voltage power supply Vb is disposed outside the front substrate 2, thus the potential variations of the metal back (the acceleration electrode) 17 can be suppressed when the abnormal discharge occurs, thereby reducing the discharge energy.

Although in the embodiments described above, the structure using the MIM type as the electron source is exemplified, the invention is not limited to such a structure, but can also be applied in the same manner to the light emitting FPD using various kinds of electron sources as described above.

What is claimed is:

1. An image display device comprising:
a rear substrate including
a plurality of scanning signal lines extending in one direction and disposed in parallel in another direction perpendicular to the one direction,
a plurality of image signal lines extending in the another direction and disposed in parallel in the one direction so as to intersect the scanning signal lines,
an interlayer insulating film disposed between the image signal lines and the scanning signal lines, and
a plurality of electron sources respectively disposed in the vicinities of intersections between the scanning signal lines and the image signal lines;
a front substrate opposed to the rear substrate with a predetermined distance and having a fluorescent film including fluorescent layers disposed correspondingly to the electron sources, and an acceleration electrode for accelerating electrons emitted from the electron sources so as to direct the electrons towards the fluorescent layers;
a frame member interposed between the rear substrate and the front substrate so as to surround a display area and for maintaining the predetermined distance;
a seal member for hermetically sealing the frame member with the front substrate and the frame member with the rear substrate;
a first translucent conductive layer disposed on a front surface of the front substrate;
a translucent insulating member disposed on a front surface of the first translucent conductive layer; and
a second translucent conductive layer held at a ground potential and disposed on a front surface of the translucent insulating member.

2. The image display device according to claim 1,
wherein surface resistances of the first translucent conductive layer and the second translucent conductive layer have values within a range of 10² Ω/sq through 10¹¹ Ω/sq.

3. The image display device according to claim 1,
wherein the translucent insulating member is an insulating layer.

4. The image display device according to claim 1,
wherein the translucent insulating member is a glass plate.

5. An image display device comprising:
a rear substrate including
a plurality of scanning signal lines extending in one direction and disposed in parallel in another direction perpendicular to the one direction,
a plurality of image signal lines extending in the another direction and disposed in parallel in the one direction so as to intersect the scanning signal lines,
an interlayer insulating film disposed between the image signal lines and the scanning signal lines, and
a plurality of electron sources respectively disposed in the vicinities of intersections between the scanning signal lines and the image signal lines;
a front substrate opposed to the rear substrate with a predetermined distance and having a fluorescent film including fluorescent layers disposed correspondingly to the electron sources, and an acceleration electrode for accelerating electrons emitted from the electron sources so as to direct the electrons towards the fluorescent layers;
a frame member interposed between the rear substrate and the front substrate so as to surround a display area and for maintaining the predetermined distance;
a seal member for hermetically sealing the frame member with the front substrate and the frame member with the rear substrate;
a first translucent conductive layer held at a lower potential than the potential of the acceleration electrode disposed on a front surface of the front substrate;
a translucent insulating member disposed on a front surface of the first translucent conductive layer; and
a second translucent conductive layer held at a ground potential and disposed on a front surface of the translucent insulating member.

6. The image display device according to claim 5,
wherein surface resistances of the first translucent conductive layer and the second translucent conductive layer have values within a range of 10² Ω/sq through 10¹¹ Ω/sq.

7. The image display device according to claim 5,
wherein the translucent insulating member is an insulating layer.

8. The image display device according to claim 5,
wherein the translucent insulating member is a glass plate.
